(19) United States
(12) Patent Application Publication
(10) Pub. No.: US 2026/0329864 A1
(43) Pub. Date: Oct. 22, 2026

(54) Smart Question Answer Method, Apparatus, Device, and Storage Medium

(71) Applicant: ALIBABA INNOVATION PRIVATE LIMITED, Singapore (SG)

(72) Inventors: Bowen YU, Beijing (CN); Haiyang YU, Beijing (CN); Fei HUANG, Sunnyvale, CA (US); Yongbin LI, Beijing (CN)

(21) Appl. No.: 19/108,710

(22) PCT Filed: Dec. 26, 2023
(86) PCT No.: PCT/CN2023/142152

§ 371 Date: Mar. 4, 2025

(30) Foreign Application Priority Data
Jan. 4, 2023 (CN) 202310008600.1

(51) Int. Cl. G06F 16/2455

(52) U.S. Cl. CPC G06F 16/2455

(57) ABSTRACT

The present disclosure relates to a smart question answer method, an apparatus, a device, and a storage medium. The preset text information is analyzed to obtain a structured information set corresponding to the preset text information. Since the speed of querying the target structured information from the structured information set is faster than directly searching for an answer from the preset text information, querying the target structured information and generating the response information based on the target structured information can improve the efficiency of generating the response information, effectively reduce the delay of the response information, and ensure that the user can promptly obtain the response information.

The present disclosure claims priority of Chinese Patent Application No. 202310008600.1, filed to China National Intellectual Property Administration on Jan. 4, 2023 and titled “Smart Question Answer Method, Apparatus, Device, and Storage medium”, the content of which is hereby incorporated by reference in its entirety.

### TECHNICAL FIELD

The present disclosure relates to the field of information technology, and more particularly, to a smart question answer method, an apparatus, a device, and a storage medium.

### BACKGROUND OF THE INVENTION

With the continuous development of technology, a smart question answer system engages in conversation with users in order to answer questions posed by the users.

Some existing smart question answer systems, after receiving a user question, are required to analyze text content online so as to find an answer to the user question from the text content and provide the answer as a response. However, when the amount of data in the text content is large, analyzing the text content online will result in time-consuming analysis processes, leading to significant response delays. Furthermore, the answer found from the text content is a portion of an original text of the text content, and the semantics of this portion of the original text may be incomplete, thereby causing response content to be insufficiently comprehensive and accurate.

### SUMMARY OF THE INVENTION

In order to solve the technical problem or at least partially solve the technical problem mentioned above, some embodiments of the present disclosure provide a smart question answer method, an apparatus, a device, and a storage medium, so as to effectively reduce the delay of response information and ensure that the response information is comprehensive and accurate.

In a first aspect, some embodiments of the present disclosure provide a smart question answer method, including that:
preset text information is analyzed to obtain a structured information set corresponding to the preset text information;
question information is acquired;
target structured information matching the question information is queried from the structured information set; and
response information corresponding to the question information is generated based on the target structured information.

In a second aspect, some embodiments of the present disclosure provide a smart question answer apparatus, including:
an analysis module arranged for analyzing preset text information to obtain a structured information set corresponding to the preset text information;
an acquisition module arranged for acquiring question information;
a query module arranged for querying target structured information matching the question information from the structured information set; and
a generation module arranged for generating response information corresponding to the question information based on the target structured information.

In a third aspect, some embodiments of the present disclosure provide a smart question answer method, and the method includes that:
question information is received from a terminal;
target structured information matching the question information is queried from a structured information set corresponding to preset text information;
response information corresponding to the question information is generated based on the target structured information; and
the response information is fed back to the terminal.

In a fourth aspect, some embodiments of the present disclosure provide an electronic device, including:
a memory;
a processor; and
a computer program;
where the computer program is stored in the memory and is arranged for being executed by the processor to implement the method described in the first aspect or the third aspect.

In a fifth aspect, some embodiments of the present disclosure provide a computer-readable storage medium storing a computer program, where the computer program is executed by a processor to implement the method described in the first aspect or the third aspect.

In a sixth aspect, some embodiments of the present disclosure provide a server, including:
a memory;
a processor; and
a computer program;
where the computer program is stored in the memory and is arranged for being executed by the processor to implement the method described in the first aspect or the third aspect.

Through the smart question answer method, the apparatus, the device, and the storage medium provided by some embodiments of the present disclosure, the preset text information is analyzed to obtain a structured information set corresponding to the preset text information. When a user asks a question, target structured information matching question information is queried from the structured information set, and response information corresponding to the question information is generated based on the target structured information. Since the speed of querying the target structured information from the structured information set is faster than directly searching for an answer from the preset text information, querying the target structured information and generating the response information based on the target structured information can improve the efficiency of generating the response information, effectively reduce the delay of the response information, and ensure that the user can promptly obtain the response information. Additionally, since the structured information set corresponding to the preset text information can be obtained in advance, the structured information in the structured information set can be supplemented and corrected in advance to ensure that the structured information in the structured information set is comprehensive and accurate. When the user asks a question, it can be ensured that the target structured information matching the question information queried from the structured information set is comprehensive and accurate, ultimately ensuring that the response information generated based on the target structured information is comprehensive and accurate.

### BRIEF DESCRIPTION OF DRAWINGS

The drawings herein are incorporated into and form part of the specification, illustrating embodiments in accordance with the present disclosure and together with the description serve to explain the principles of the present disclosure.

In order to more clearly describe the technical solutions of the embodiments of the present disclosure or the prior art, the following briefly introduces the drawings required for describing the embodiments or the prior art. It is apparent that a person having ordinary skill in the art can obtain other drawings based on these drawings without expending inventive effort.

FIG. 1 is a flowchart of a smart question answer method according to some embodiments of the present disclosure.

FIG. 2 is a schematic diagram of an application scenario according to some embodiments of the present disclosure.

FIG. 3 is a flowchart of another smart question answer method according to some embodiments of the present disclosure.

FIG. 4 is a flowchart of another smart question answer method according to some embodiments of the present disclosure.

FIG. 5 is a flowchart of another smart question answer method according to some embodiments of the present disclosure.

FIG. 6 is a structural schematic diagram of a smart question answer apparatus according to some embodiments of the present disclosure.

FIG. 7 is a structural schematic diagram of an electronic device according to some embodiments of the present disclosure.

FIG. 8 is a schematic diagram of another application scenario according to some embodiments of the present disclosure.

FIG. 9 is a schematic diagram of yet another application scenario according to some embodiments of the present disclosure.

### DETAILED DESCRIPTION OF THE INVENTION

In order to better understand objectives, features, and advantages of the present disclosure, the solutions of the present disclosure will be further described below. It should be noted that the embodiments of the present disclosure and the features in the embodiments can be combined with each other without conflict.

In the following description, many specific details are set forth in order to fully understand the present disclosure. However, the present disclosure can further be implemented in other ways different from those described herein. Obviously, the embodiments described in the specification are part of the embodiments of the present disclosure, not all of the embodiments of the present disclosure.

It should be noted that the question information involved in the present application (including but not limited to questions, interrogative sentences, inquiries, videos, etc., input by users during the conversation between users and human-machine interaction systems) are all authorized by users or sufficiently authorized by all relevant parties. Moreover, the collection, use, and processing of related data must comply with relevant national and regional laws, regulations, and standards, and corresponding operation interfaces are provided for users to choose authorization or refusal.

In addition, the smart question answer method provided by the present disclosure involves the following terminologies, detailed as follows:
doc2bot: document question answer service.

Transformer: a text context encoding-decoding model based on self-attention mechanisms.

Under normal circumstances, a smart question answer system converses with users to answer questions raised by users. However, some current smart question answer systems, after receiving user questions, analyze text content to extract corresponding answers from the text as replies. This not only causes significant response delays but also results in replies that are insufficiently comprehensive and accurate. To address this problem, some embodiments of the present disclosure provide a smart question answer method, which will be introduced below in conjunction with specific embodiments.

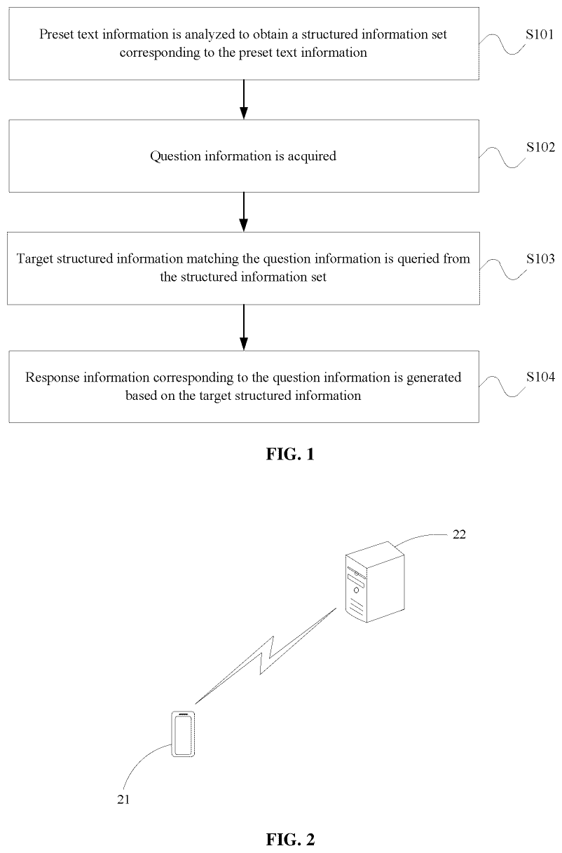

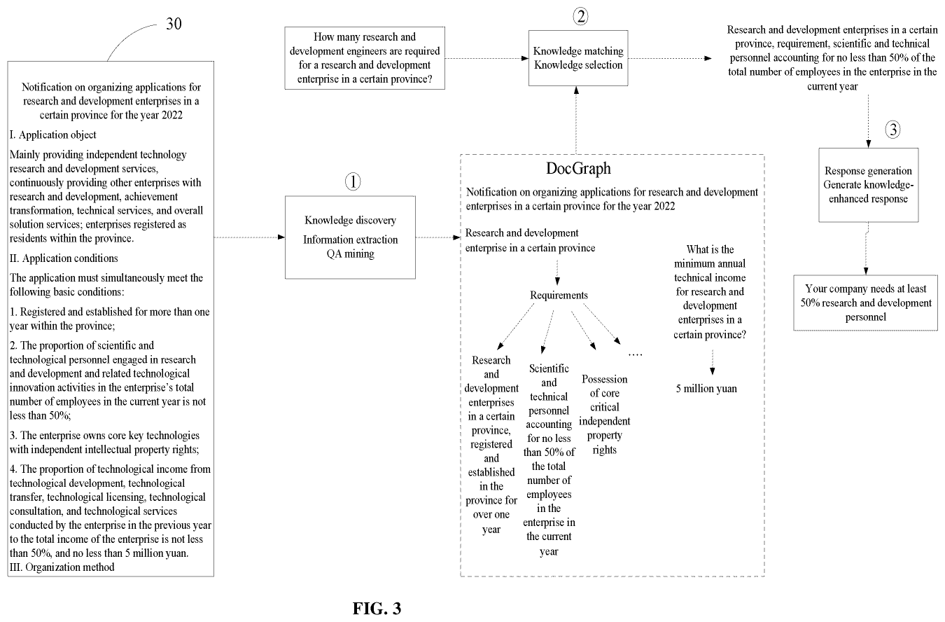

FIG. 1 is a flowchart of a smart question answer method according to some embodiments of the present disclosure. This method is executed by a smart question answer apparatus, which is implemented in software and/or hardware. The apparatus is arranged in an electronic device such as a server or a terminal. The terminal specifically includes a mobile phone, a computer, or a tablet computer, and so on. This method is applied to the application scenario as shown in FIG. 2. The application scenario includes a terminal 21 and a server 22. The terminal 21 sends question information to the server 22. The server 22 generates response information corresponding to the question information using the method described in some embodiments, and then feeds back the response information to the terminal 21, thereby achieving smart question answer. As shown in FIG. 1, the specific steps of the method are as follows.

In step S101, preset text information is analyzed to obtain a structured information set corresponding to the preset text information.

In various industry enterprises, more than 80%-90% of data is unstructured data, and among these, unstructured documents account for the most significant proportion. Therefore, the present embodiment primarily provides users with corresponding question-answer service based on the unstructured documents. Specifically, some embodiments of the present disclosure record the content of the unstructured documents as preset text information and obtain a structured information set corresponding to the preset text information through analysis of the preset text information. As shown in FIG. 3, a block 30 represents the preset text information. Through knowledge discovery as indicated by \textcircled{1}, the structured information set corresponding to the preset text information is obtained, and this structured information set is a Document Graph (DocGraph) as shown in FIG. 3. The knowledge discovery includes information extraction and Question Answer (QA) mining. It can be understood that, in some embodiments, the preset text information is pre-stored information in a server 22. The server 22 performs information extraction and QA mining on the preset text information in an offline state to obtain the DocGraph. The DocGraph is further referred to as a structured knowledge set. Specifically, the DocGraph is composed of structured information or structured knowledge. As shown in FIG. 3, examples of structured information or structured knowledge within the DocGraph include: (research and development enterprises in a certain province, requirement, registered and established in the province for over one year), (research and development enterprises in a certain province, requirement, scientific and technical personnel accounting for no less than 50% of the total number of employees in the enterprise in the current year), (research and development enterprises in a certain province, requirement, possession of core critical independent property rights), and (What is the minimum annual technical income for research and development enterprises in a certain province? 5 million yuan).

In step S102, question information is acquired.

For example, the server 22 receives question information sent from the terminal 21, and the question information is a user interrogative sentence, such as “How many research and development engineers are required for a research and development enterprise in a certain province?” as shown in FIG. 3. In some other embodiments, the question information is further a declarative question, such as “Check the inventory of red shirts.”

In step S103, target structured information matching the question information is queried from the structured information set.

For example, the server 22 selects the target structured information matching the question information from the DocGraph through knowledge grounding indicated by \textcircled{2}. An example of the target structured information includes that, for each research and development enterprise in a certain province, the proportion of scientific and technical personnel to the total number of employees of this enterprise in the current year is not less than 50%. The knowledge grounding includes knowledge selection.

In step S104, response information corresponding to the question information is generated based on the target structured information.

For example, the server 22 generates response information corresponding to the target structured information through response generation as shown in \textcircled{3}, such as the response information being “Your company needs at least 50% research and development personnel.” as shown in FIG. 3.

Through the embodiments of the present disclosure, the preset text information is analyzed to obtain a structured information set corresponding to the preset text information. When a user asks a question, target structured information matching question information is queried from the structured information set, and response information corresponding to the question information is generated based on the target structured information. Since the speed of querying the target structured information from the structured information set is faster than directly searching for an answer from the preset text information, querying the target structured information and generating the response information based on the target structured information can improve the efficiency of generating the response information, effectively reduce the delay of the response information, and ensure that the user can promptly obtain the response information. Additionally, since the structured information set corresponding to the preset text information can be obtained in advance, the structured information in the structured information set can be supplemented and corrected in advance to ensure that the structured information in the structured information set is comprehensive and accurate. When the user asks a question, it can be ensured that the target structured information matching the question information queried from the structured information set is comprehensive and accurate, ultimately ensuring that the response information generated based on the target structured information is comprehensive and accurate.

In some embodiments, an operation of analyzing the preset text information includes the following steps. The preset text information and a preset type are input into a machine learning model, so that the machine learning model extracts target content matching the preset type from the preset text information, the preset type and the target content constituting structured information.

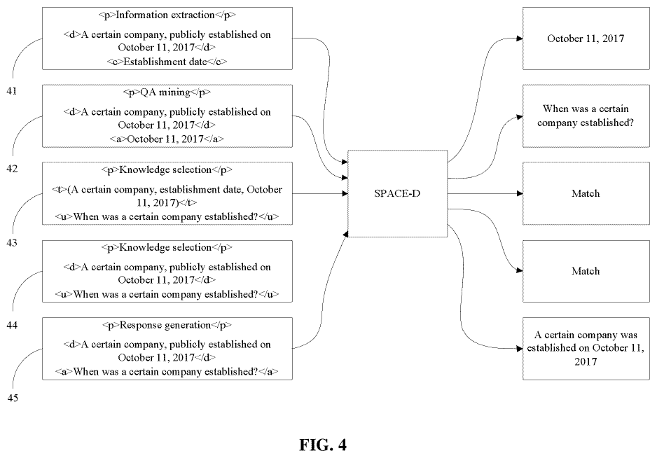

As shown in FIG. 3, some embodiments of the present disclosure parse structured information from preset text information through information extraction. As shown in FIG. 4, for information extraction, the preset text information (e.g., “a company, publicly established on Oct. 11, 2017”) and a preset type (e.g., “establishment date”) are input into the machine learning model (such as the document-dialog pre-training model SPACE-D), so that the machine learning model extracts target content matching the preset type from the preset text information, the target content for example being “Oct. 11, 2017”. Further, the preset type (e.g., “establishment date”) and the target content (e.g., “Oct. 11, 2017”) constitute structured information, which is represented as a binary tuple (establishment date, Oct. 11, 2017).

In some embodiments, an operation of inputting the preset text information and the preset type into the machine learning model, so that the machine learning model extracts the target content matching the preset type from the preset text information includes the following steps. A representation vector of a sequence consisting of the name of a first task, the preset text information, and the preset type is input into the machine learning model, the first task being used for information extraction. The target content in the preset text information matching the preset type is determined based on outputs of multiple atomic capabilities corresponding to the first task within the machine learning model.

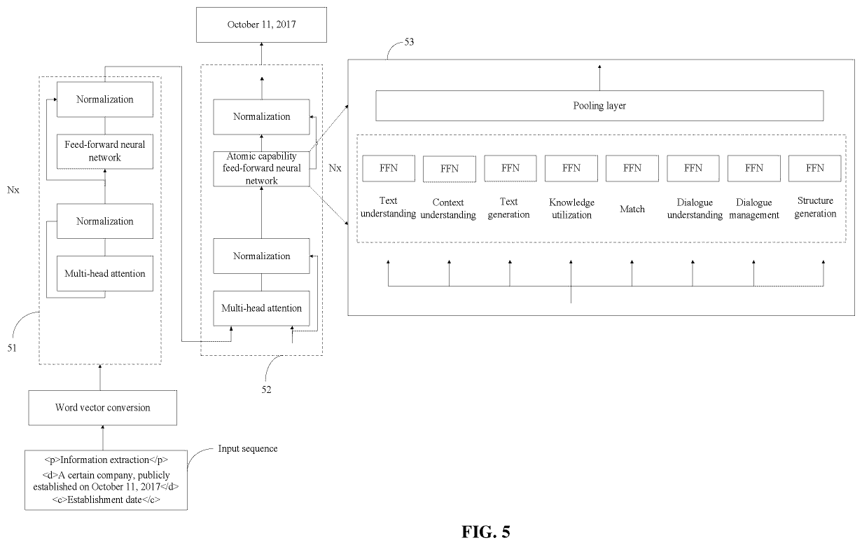

In some embodiments, information extraction as shown in FIG. 3 is denoted as the first task, QA mining is denoted as the second task, knowledge selection is denoted as the third task, and response generation is denoted as the fourth task. Each type of task is decomposed into multiple atomic capabilities. For example, the first task and the second task are respectively decomposed into four atomic capabilities including text understanding, structure generation, context understanding, and text generation. The third task is decomposed into four atomic capabilities including text understanding, dialogue understanding, matching, and text generation. The fourth task is decomposed into five atomic capabilities including dialogue understanding, dialogue management, text generation, knowledge utilization, and text understanding. That is, different tasks are realized by combinations of different atomic capabilities, and these four tasks involve a total of eight atomic capabilities. As shown in FIG. 5, each atomic capability corresponds to a different FFN function within the Transformer network. Below is an introduction to these eight atomic capabilities.

Text understanding: in the knowledge discovery task, the text understanding specifically refers to comprehending a sentence within the preset text information. In the knowledge selection task and the response generation task, the text understanding specifically refers to comprehending the question information.

Structure generation: in the knowledge discovery task, the structure generation specifically refers to generating structured information or structured knowledge.

Context understanding: in the knowledge discovery task, the context understanding specifically refers to comprehending the content of the entire document.

Text generation: in the knowledge discovery task, the text generation specifically refers to generating interrogative sentences in the DocGraph, such as “What is the minimum annual technical revenue for research and development enterprises in a certain province?”. In the knowledge selection task, the text generation specifically refers to generating result information indicating whether any structured information in the DocGraph matches the question information. In the response generation task, the text generation specifically refers to generating response information corresponding to the question information.

Dialogue understanding: in the knowledge selection task and the response generation task, the dialogue understanding specifically refers to comprehending the historical dialogues in the human-machine dialogue process.

Matching: in the knowledge selection task, the matching refers to determining whether any structured information in the DocGraph matches the question information.

Dialogue management: in the response generation task, the dialogue management specifically refers to managing the logic, completeness, and coherence of dialogues in the human-machine dialogue process.

Knowledge utilization: in the response generation task, the knowledge utilization specifically refers to utilizing the structured information or structured knowledge matched by the knowledge selection task to generate response information corresponding to the question information.

The Transformer network shown in FIG. 5 is the aforementioned machine learning model. Specifically, the Transformer network includes an encoder 51 and a decoder 52 as shown in FIG. 5, and the internal structures of the encoder 51 and the decoder 52 are also shown in FIG. 5. The internal structure of the atomic capability feed-forward neural network in the decoder 52 is shown as a block 53 in FIG. 5. In some embodiments, the encoder 51 includes N blocks with identical structures, and the decoder 52 further includes N blocks with identical structures.

It can be understood that since different tasks can be realized by combinations of different atomic capabilities, when realizing different tasks through the Transformer network, the FFN functions involved in the calculations within the Transformer network may differ. For example, when realizing the information extraction task or the QA mining task through the Transformer network, the FFN functions corresponding to the four atomic capabilities including the text understanding, the structure generation, the context understanding, and the text generation are involved in the decoding process of the decoder 52. When realizing the knowledge selection task through the Transformer network, the FFN functions corresponding to the four atomic capabilities including the text understanding, the dialogue understanding, the matching, and the text generation are involved in the decoding process of the decoder 52. When realizing the response generation task through the Transformer network, the FFN functions corresponding to the five atomic capabilities including the dialogue understanding, the dialogue management, the text generation, the knowledge utilization, and the text understanding are involved in the decoding process of the decoder 52.

As shown in FIG. 5, taking the information extraction task as an example, a task name (e.g., “information extraction”), the preset text information (e.g., “a company, publicly established on Oct. 11, 2017”), and the preset type (e.g., “establishment date”) together form the input sequence. That is, the content in block 41 as shown in FIG. 4 serves as the input sequence. Additionally, some preset characters (e.g., <p> . . . </p>, <d> . . . </d>, <c> . . . </c>) are used for distinguishing between the task name, the preset text information, and the preset type. Further, through word vector transformation, each word, phrase, or character in the input sequence is converted into a corresponding representation vector, so that the representation vectors of the words, phrases, or characters are concatenated together to form the representation vector of the input sequence. The representation vector of the input sequence undergoes processing sequentially by the encoder 51 and the decoder 52. Since the information extraction task is decomposed into four atomic capabilities including the text understanding, the structure generation, the context understanding, and the text generation in the atomic capability feed-forward neural network, the FFN functions corresponding to these four atomic capabilities including the text understanding, the structure generation, the context understanding, and the text generation have respective outputs. Further, the pooling layer processes the outputs of the FFN functions corresponding to these four atomic capabilities, for example, through averaging the outputs of the FFN functions corresponding to these four atomic capabilities, normalization is applied to the average value to obtain the target content in the preset text information that matches the preset type, such as “Oct. 11, 2017”. It can be understood that the processing from the input sequence to the target content described here can be regarded as the usage phase or inference phase of the machine learning model. During the training process of the machine learning model, following the process as shown in FIG. 5, the output “Oct. 11, 2017” generated by the machine learning model can serve as the prediction result of the machine learning model. Further, based on the prediction result and the standard content pre-labeled in the preset text information (such as “Oct. 11, 2017”), the machine learning model can be trained, particularly training the FFN functions corresponding to the four atomic capabilities including the text understanding, the structure generation, the context understanding, and the text generation within the machine learning model, thereby enabling the trained machine learning model to complete the information extraction task.

In some embodiments, an operation of analyzing the preset text information includes the following steps. The preset text information and key fields in the preset text information are input into a machine learning model, so that the machine learning model generates interrogative sentence information corresponding to the key fields, the key fields and the interrogative sentence information constituting structured information.

As shown in FIG. 3, some embodiments of the present disclosure further parse structured information from preset text information through QA mining. As shown in FIG. 4, for the QA mining, the preset text information (e.g., “a company, publicly established on Oct. 11, 2017”) and a key field (e.g., “Oct 11, 2017”) within the preset text information are input into the machine learning model (such as SPACE-D), so that the machine learning model generates interrogative information (e.g., “When was this company established?”) corresponding to the key field. Further, the key field and the interrogative information constitute the structured information. That is, the content in the preset text information forms the structured information or structured knowledge in the form of a statement, or the content in the preset text information forms the structured information or the structured knowledge in the form of question-and-answer.

In some embodiments, an operation of inputting the preset text information and the key fields in the preset text information into the machine learning model, so that the machine learning model generates the interrogative sentence information corresponding to the key fields includes the following steps. A representation vector of a sequence consisting of the name of a second task, the preset text information, and the key fields in the preset text information is input into the machine learning model, the second task being used for mining question-answer information. The interrogative sentence information corresponding to the key fields is generated based on outputs of multiple atomic capabilities corresponding to the second task within the machine learning model.

For example, when the input sequence in FIG. 5 is replaced with the content in a block 42 as shown in FIG. 4, the QA mining task is realized through the machine learning model as shown in FIG. 5. Specifically, through word vector transformation as shown in FIG. 5, each word, phrase, or character in the input sequence is converted into a corresponding representation vector, such that the representation vectors of the words, phrases, or characters are concatenated together to form the representation vector of the input sequence. The representation vector of the input sequence is processed sequentially through the encoder 51 and the decoder 52. Since the QA mining task is decomposed into four atomic capabilities including text understanding, structure generation, context understanding, and text generation, in the atomic capability feed-forward neural network, the FFN functions corresponding to these four atomic capabilities including the text understanding, the structure generation, the context understanding, and the text generation have respective outputs. Further, the pooling layer processes the outputs of the FFN functions corresponding to these four atomic capabilities, for example through averaging the outputs of the FFN functions corresponding to these four atomic capabilities, normalization is applied to the average value to generate interrogative information corresponding to the key fields, such as “When was a company established?”. By analogy, this process can represent the model usage phase or inference phase of the machine learning model for realizing the QA mining task. During the training process of the machine learning model, the machine learning model is trained based on the output of the machine learning model and pre-labeled interrogative information, particularly training the FFN functions corresponding to the four atomic capabilities including the text understanding, the structure generation, the context understanding, and the text generation within the machine learning model, thereby enabling the trained machine learning model to complete the QA mining task.

In some embodiments, an operation of querying the target structured information matching the question information from the structured information set includes the following steps. Any structured information in the structured information set and the question information are input into a machine learning model, so that the machine learning model determines whether the any structured information matches the question information, and in response to the any structured information matching the question information, the any structured information is the target structured information matching the question information.

As shown in FIG. 4, for knowledge selection, any structured information, for example a triple (a company, establishment date, Oct. 11, 2017), from the DocGraph and question information, for example “When was this company established?”, are input into the machine learning model (such as SPACE-D), so that the machine learning model determines whether the any structured information matches the question information. In response to the any structured information matching the question information, the machine learning model outputs “match”, thereby allowing the any structured information to serve as the target structured information matching the question information.

Alternatively, as shown in FIG. 4, for knowledge selection, preset text information, for example a company, publicly established on Oct. 11, 2017, and question information, for example “When was this company established?”, are input into the machine learning model (such as SPACE-D), so that the machine learning model determines whether the preset text information matches the question information. In response to the preset text information matching the question information, the machine learning model outputs “match”, thereby allowing the preset text information to serve as the target text information matching the question information.

In some embodiments, an operation of inputting the any structured information in the structured information set and the question information into the machine learning model, so that the machine learning model determines whether the any structured information matches the question information includes the following steps. A representation vector of a sequence consisting of the name of a third task, the any structured information in the structured information set, and the question information is input into the machine learning model, the third task being used for selecting structured information matching the question information. Information indicating whether the any structured information matches the question information is generated based on outputs of multiple atomic capabilities corresponding to the third task within the machine learning model.

For example, when the input sequence in FIG. 5 is replaced with the content in a block 43 or a block 44 as shown in FIG. 4, the knowledge selection task is realized through the machine learning model as shown in FIG. 5. Since the knowledge selection task is decomposed into four atomic capabilities including text understanding, dialogue understanding, matching, and text generation, during the decoding process, based on the outputs of the FFN functions corresponding to these four atomic capabilities including the text understanding, the dialogue understanding, the matching, and the text generation, a conclusion can be obtained as to whether any structured information matches the question information or whether the preset text information matches the question information.

In some embodiments, an operation of generating the response information corresponding to the question information based on the target structured information includes the following steps. The response information corresponding to the question information is generated based on the target structured information and the question information.

For the response generation task, the target structured information that has been matched (e.g., a company, establishment date, Oct. 11, 2017) and the question information (e.g., when was this company established?) are input into the machine learning model (such as SPACE-D), so that the machine learning model generates response information corresponding to the question information, for example, this company was established on Oct. 11, 2017.

Alternatively, as shown in FIG. 4, for the response generation task, the target text information that has been matched (e.g., a company publicly established on Oct. 11, 2017) and the question information (e.g., when was this company established?) are input into the machine learning model (such as SPACE-D), so that the machine learning model generates response information corresponding to the question information, for example, this company was established on Oct. 11, 2017.

In some embodiments, an operation of generating the response information corresponding to the question information based on the target structured information and the question information includes the following steps. A representation vector of a sequence consisting of the name of a fourth task, the target structured information, and the question information is input into the machine learning model, the fourth task being used for generating the response information. The response information corresponding to the question information is generated based on outputs of multiple atomic capabilities corresponding to the fourth task within the machine learning model.

For example, when the input sequence as shown in FIG. 5 is replaced with the content in a block 45 as shown in FIG. 4, the response generation task can be realized through the machine learning model as shown in FIG. 5. Since the response generation task is decomposed into five atomic capabilities including dialogue understanding, dialogue management, text generation, knowledge utilization, and text understanding, during the realization of the response generation task, in the decoder 52, the response information corresponding to the question information is generated based on the outputs of the FFN functions corresponding to these five atomic capabilities including the dialogue understanding, the dialogue management, the text generation, the knowledge utilization, and the text understanding.

It should be understood that the process of realizing the information extraction task, the QA mining task, the knowledge selection task, and the response generation task through the machine learning model is regarded as the usage phase or inference phase of the machine learning model. During the training of the machine learning model, the multiple atomic capabilities resulting from the decomposition of each task are trained. For example, the multiple atomic capabilities corresponding to the information extraction task, the QA mining task, the knowledge selection task, and the response generation task are trained sequentially. Thus, one single machine learning model can model multiple tasks, thereby enabling the trained machine learning model to possess the functionality of realizing multiple tasks.

In some embodiments of the present disclosure, through decomposing each task among multiple tasks into multiple atomic capabilities, different tasks can achieve modular network design through sparse capability combinations. This allows for the comprehensive use of various types of knowledge under conditions of limited labeled data to generate smooth and reasonable multi-round question answer. Additionally, in some embodiments of the present disclosure, unified modeling of multiple key tasks related to smart question answer based on document content can be achieved for the first time. That is, one machine learning model can perform unified modeling of multiple key tasks, thereby improving modeling efficiency.

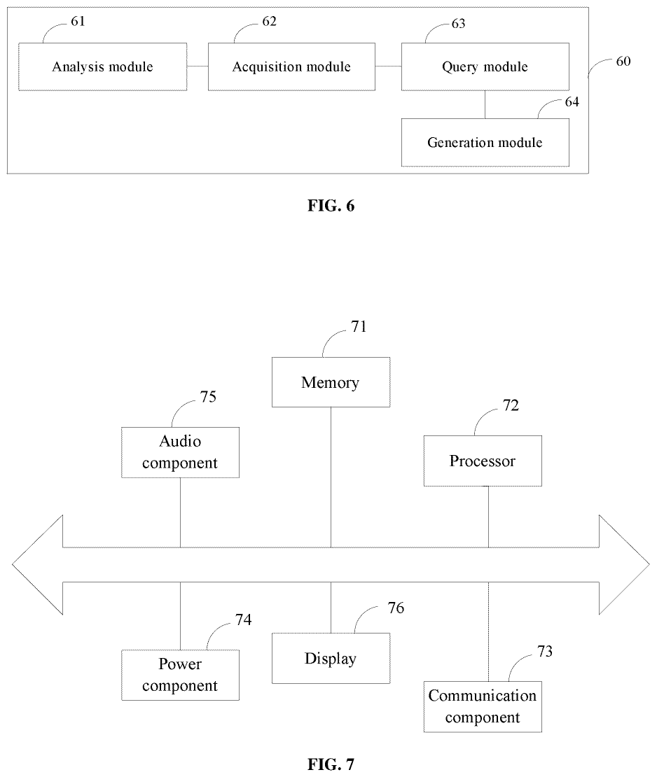

FIG. 6 is a structural schematic diagram of a smart question answer apparatus according to some embodiments of the present disclosure. The smart question answer apparatus provided by some embodiments of the present disclosure is arranged for executing the processing flow of the smart question answer method provided by some embodiments of the present disclosure. As shown in FIG. 6, the smart question answer apparatus includes:
an analysis module 61 arranged for analyzing preset text information to obtain a structured information set corresponding to the preset text information;
an acquisition module 62 arranged for acquiring question information;
a query module 63 arranged for querying target structured information matching the question information from the structured information set; and
a generation module 64 arranged for generating response information corresponding to the question information based on the target structured information.

In some embodiments, the analysis module 61 is further arranged for, when analyzing the preset text information, inputting the preset text information and a preset type into a machine learning model, so that the machine learning model extracts target content matching the preset type from the preset text information, the preset type and the target content constituting structured information.

In some embodiments, the analysis module 61 is further arranged for, when inputting the preset text information and the preset type into the machine learning model, so that the machine learning model extracts the target content matching the preset type from the preset text information, inputting a representation vector of a sequence consisting of the name of a first task, the preset text information, and the preset type into the machine learning model, the first task being used for information extraction; and determining the target content in the preset text information matching the preset type based on outputs of multiple atomic capabilities corresponding to the first task within the machine learning model.

In some embodiments, the analysis module 61 is further arranged for, when analyzing the preset text information, inputting the preset text information and key fields in the preset text information into a machine learning model, so that the machine learning model generates interrogative sentence information corresponding to the key fields, the key fields and the interrogative sentence information constituting structured information.

In some embodiments, the analysis module 61 is further arranged for, when inputting the preset text information and the key fields in the preset text information into the machine learning model, so that the machine learning model generates the interrogative sentence information corresponding to the key fields, inputting a representation vector of a sequence consisting of the name of a second task, the preset text information, and the key fields in the preset text information into the machine learning model, the second task being used for mining question-answer information; and generating the interrogative sentence information corresponding to the key fields based on outputs of multiple atomic capabilities corresponding to the second task within the machine learning model.

In some embodiments, the query module 63 is further arranged for, when querying the target structured information matching the question information from the structured information set, inputting any structured information in the structured information set and the question information into a machine learning model, so that the machine learning model determines whether the any structured information matches the question information, and in response to the any structured information matching the question information, the any structured information is the target structured information matching the question information.

In some embodiments, the query module 63 is further arranged for, when inputting the any structured information in the structured information set and the question information into the machine learning model, so that the machine learning model determines whether the any structured information matches the question information, inputting a representation vector of a sequence consisting of the name of a third task, the any structured information in the structured information set, and the question information into the machine learning model, the third task being used for selecting structured information matching the question information; and generating information indicating whether the any structured information matches the question information based on outputs of multiple atomic capabilities corresponding to the third task within the machine learning model.

In some embodiments, the generation module 64 is further arranged for, when generating the response information corresponding to the question information based on the target structured information, generating the response information corresponding to the question information based on the target structured information and the question information.

In some embodiments, the generation module 64 is further arranged for, when generating the response information corresponding to the question information based on the target structured information and the question information, inputting a representation vector of a sequence consisting of the name of a fourth task, the target structured information, and the question information into the machine learning model, the fourth task being used for generating the response information; and generating the response information corresponding to the question information based on outputs of multiple atomic capabilities corresponding to the fourth task within the machine learning model.

The smart question answer apparatus as shown in FIG. 6 is used for implementing the technical solution of the method embodiments described above, and the implementation principle and technical effects are similar, so no further details will be repeated here.

The foregoing describes the internal functions and structure of the smart question answer apparatus, which can be realized as a type of electronic device. FIG. 7 is a structural schematic diagram of an electronic device according to some embodiments of the present disclosure. As shown in FIG. 7, the electronic device includes a memory 71 and a processor 72.

The memory 71 is arranged for storing a program. In addition to the program, the memory 71 is further arranged for storing other various types of data to support operations on the electronic device. Examples of such data include instructions for any applications or methods operating on the electronic device, contact data, telephone directory data, messages, pictures, videos, etc.

The memory 71 is implemented by any type of transitory or non-transitory storage device or a combination thereof, such as static random-access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The processor 72 is coupled with the memory 71 and executes the program stored in the memory 71 for:
analyzing preset text information to obtain a structured information set corresponding to the preset text information;
acquiring question information;
querying target structured information matching the question information from the structured information set; and
generating response information corresponding to the question information based on the target structured information.

Or, the processor 72 is further arranged for:
receiving question information from a terminal;
querying target structured information matching the question information from a structured information set corresponding to preset text information;
generating response information corresponding to the question information based on the target structured information; and
feeding back the response information to the terminal.

Further, as shown in FIG. 7, the electronic device further includes: a communication component 73, a power component 74, an audio component 75, a display 76, and other components. FIG. 7 schematically illustrates some of the components and does not imply that the electronic device solely includes the components shown in FIG. 7.

The communication component 73 is arranged for facilitating wired or wireless communication between the electronic device and other devices. The electronic device accesses wireless networks based on communication standards, such as WiFi, 2G, or 3G, or combinations of the WiFi, the 2G, and the 3G. In some exemplary embodiments, the communication component 73 receives broadcast signals or broadcast-related information from an external broadcast management system via a broadcast channel. In some exemplary embodiments, the communication component 73 further includes a near-field communication (NFC) module to facilitate short-range communications. For example, the NFC module is implemented based on radio frequency identification (RFID) technology, Infrared Data Association (IrDA) technology, ultra-wideband (UWB) technology, Bluetooth (BT) technology, and other technologies.

The power component 74 provides power to various components of the electronic device. The power component 74 includes a power management system, at least one power supply, and other components associated with generating, managing, and distributing power for the electronic device.

The audio component 75 is arranged for outputting and/or inputting audio signals. For example, the audio component 75 includes a microphone (MIC), which is arranged for receiving external audio signals when the electronic device is in an operating mode, such as a call mode, a recording mode, or a voice recognition mode. The received audio signal is further stored in the memory 71 or sent via the communication component 73. In some embodiments, the audio component 75 further includes a speaker for outputting audio signals.

The display 76 includes a screen, including a liquid crystal display (LCD) and a touch panel (TP). When the screen includes a touch panel, the screen is implemented as a touchscreen to receive input signals from users. The touch panel includes at least one touch sensor to detect touches, swipes, and gestures on the touch panel. The touch sensor not only detects boundaries of touch or swipe actions but also detects duration and pressure related to the touch or swipe operations.

In addition, some embodiments of the present disclosure provide a computer-readable storage medium storing a computer program, where the computer program is executed by a processor to implement the smart question answer method described in the above embodiments.

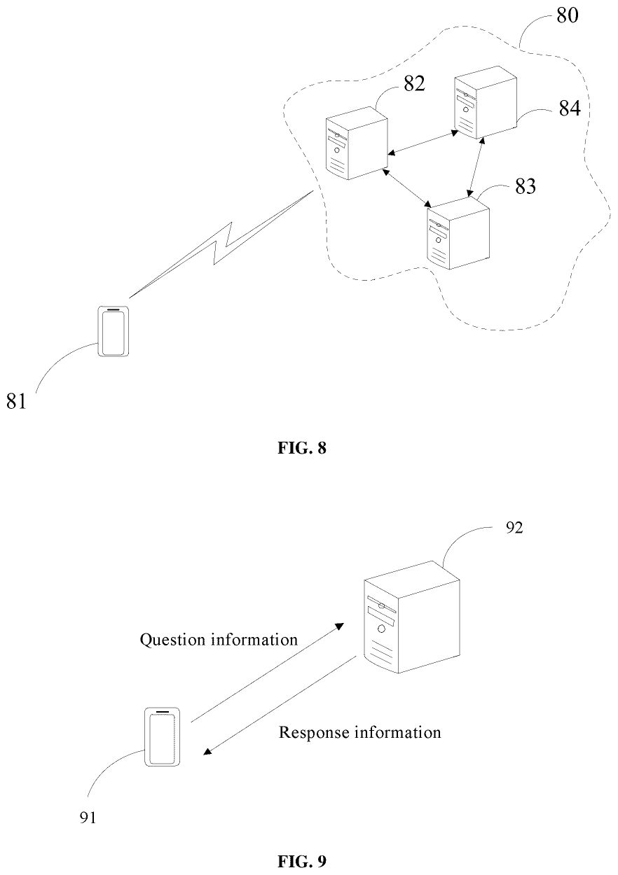

Furthermore, some embodiments of the present disclosure further provide a smart question answer method, which is executed by a cloud platform, such as a cloud platform 80 as shown in FIG. 8. The cloud platform 80 includes at least one cloud server, where each cloud server refers to a server cluster consisting of many servers with architectures similar to general-purpose computers. The composition of each cloud server includes a processor, a hard drive, a memory, a system bus, etc. As shown in FIG. 8, the cloud platform 80 includes a server 82, a server 83, and a server 84, and the server 82, the server 83, and the server 84 form a server cluster. It should be understood that the number of servers in the server cluster is not limited to those as shown in FIG. 8. It is an illustrative explanation without specific limitation. For example, when the cloud platform 80 executes the smart question answer method, the method specifically includes the following steps.

In step S81, question information is received from a terminal.

Specifically, the question information is a user query or a declarative question. For example, as shown in FIG. 8, a user inputs the user query or declarative question on a user interface provided by the terminal 81. Further, the terminal 81 sends the user query or declarative question to the cloud platform 80, and the cloud platform 80 receives the question information from the terminal 81.

In step S82, target structured information matching the question information is queried from a structured information set corresponding to preset text information.

For example, before the cloud platform 80 receives the question information from the terminal 81, the cloud platform 80 analyzes the preset text information offline to obtain the structured information set corresponding to the preset text information. The preset text information is text pre-stored in the cloud platform 80. For example, as shown in FIG. 3, the cloud platform 80 obtains the structured information set corresponding to the preset text information through knowledge discovery. Further, through knowledge grounding, the cloud platform 80 queries target structured information matching the question information from the structured information set.

In step S83, response information corresponding to the question information is generated based on the target structured information.

For example, as shown in FIG. 3, the cloud platform 80 generates response information corresponding to the question information based on the target structured information through response generation.

In step S84, the response information is fed back to the terminal.

For example, as shown in FIG. 8, the cloud platform 80 feeds back the response information corresponding to the question information to the terminal 81, so that the terminal 81 displays the response information to the user.

In addition, some embodiments of the present disclosure further provide a smart question answer method, which is executed in the cloud or locally. Specifically, this method is realized through a machine learning model, which is deployed in the cloud or locally. Specifically, the method is applied to the application scenario as shown in FIG. 9, which includes a terminal 91 and a cloud server 92. It is assumed that the method is executed by the cloud server 92, the machine learning model is deployed on the cloud server 92. Specifically, the cloud server 92 includes a processor, a hard drive, a memory, a system bus, etc. Specifically, the terminal 91 provides a user interface where the user inputs question information, such as a user query or declarative question. Further, the terminal 91 sends the question information to the cloud server 92. Internally, the cloud server 92 refers to the process as shown in FIG. 3, analyzing pre-stored unstructured documents offline to obtain a structured information set, such as a document graph (DocGraph). For example, through the knowledge discovery indicated by \textcircled{1}, the cloud server 92 obtains the structured information set. During the knowledge discovery process, the processing of the machine learning model deployed in the cloud server 92 is as shown in the content processing of a block 41 or a block 42 in FIG. 4. When the cloud server 92 receives the question information, the cloud server 92 can select target structured information matching the question information from the DocGraph through knowledge grounding indicated by \textcircled{2}. During the knowledge grounding process, the processing of the machine learning model deployed in the cloud server 92 is as shown in the content processing of a block 43 in FIG. 4. Further, the cloud server 92 generates response information corresponding to the question information based on the target structured information through response generation indicated by \textcircled{3}. During the response generation process, the processing of the machine learning model deployed in the cloud server 92 is as shown in the content processing of a block 44 in FIG. 4. Further, the cloud server 92 feeds back the response information corresponding to the question information to the terminal 91, so that the terminal 91 displays the response information to the user. Based on the method described in this embodiment, the user engages in multi-round dialogues with the cloud server 92.

It should be understood that the cloud server 92 pre-stores a large amount of unstructured documents. Through the knowledge discovery indicated by \textcircled{1}, one unstructured document is converted into one structured information set. Thus, each unstructured document corresponds to one structured information set. In some embodiments, the cloud server 92 further merges the structured information set corresponding to each unstructured document into a larger structured information set, which ensures that when the cloud server 92 receives different question information, the cloud server 92 queries target structured information from the larger structured information set and generates response information corresponding to the question information.

In addition, some embodiments of the present disclosure further provide a server, including:
a memory;
a processor; and
a computer program;
where the computer program is stored in the memory and is arranged for being executed by the processor to implement the smart question answer method described above.

It should be noted that relational terms such as “first” and “second” are used herein for distinguishing one entity or operation from another entity or operation, and do not necessarily require or imply any actual relationship or order between these entities or operations. Furthermore, the terms “include”, “contain” or any other variation thereof are intended to cover non-exclusive inclusion, such that a process, a method, an item, or a device that includes a series of elements not only includes those elements but also includes other elements not explicitly listed, or includes inherent elements of such the process, the method, the item, or the device. Without further limitation, an element defined by the phrase “including one . . . ” does not exclude the presence of additional identical elements in the process, the method, the item, or the device including the element.

All of the above are specific implementations of the present disclosure. These embodiments enable a person having ordinary skill in the art to understand or implement the present disclosure. Various modifications to these embodiments will be apparent to a person having ordinary skill in the art, and the general principles defined herein may be implemented in other embodiments without departing from the spirit or scope of the present disclosure. Therefore, the present disclosure will not be limited to the embodiments described herein but will conform to the widest scope consistent with the principles and novel features disclosed herein.

1. A smart question answer method, wherein the method comprises:
analyzing preset text information to obtain a structured information set corresponding to the preset text information;
acquiring question information;
querying target structured information matching the question information from the structured information set; and
generating response information corresponding to the question information based on the target structured information.

2. The method according to claim 1, wherein analyzing the preset text information comprises:
inputting the preset text information and a preset type into a machine learning model, so that the machine learning model extracts target content matching the preset type from the preset text information, the preset type and the target content constituting structured information.

3. The method according to claim 2, wherein inputting the preset text information and the preset type into the machine learning model, so that the machine learning model extracts the target content matching the preset type from the preset text information comprises:
inputting a representation vector of a sequence consisting of the name of a first task, the preset text information, and the preset type into the machine learning model, the first task being used for information extraction; and
determining the target content in the preset text information matching the preset type based on outputs of a plurality of atomic capabilities corresponding to the first task within the machine learning model.

4. The method according to claim 1, wherein analyzing the preset text information comprises:
inputting the preset text information and key fields in the preset text information into a machine learning model, so that the machine learning model generates interrogative sentence information corresponding to the key fields, the key fields and the interrogative sentence information constituting structured information.

5. The method according to claim 4, wherein inputting the preset text information and the key fields in the preset text information into the machine learning model, so that the machine learning model generates the interrogative sentence information corresponding to the key fields comprises:
inputting a representation vector of a sequence consisting of the name of a second task, the preset text information, and the key fields in the preset text information into the machine learning model, the second task being used for mining question-answer information; and
generating the interrogative sentence information corresponding to the key fields based on outputs of a plurality of atomic capabilities corresponding to the second task within the machine learning model.

6. The method according to claim 1, wherein querying the target structured information matching the question information from the structured information set comprises:
inputting any structured information in the structured information set and the question information into a machine learning model, so that the machine learning model determines whether the any structured information matches the question information, and in response to the any structured information matching the question information, the any structured information is the target structured information matching the question information.

7. The method according to claim 6, wherein inputting the any structured information in the structured information set and the question information into the machine learning model, so that the machine learning model determines whether the any structured information matches the question information comprises:
inputting a representation vector of a sequence consisting of the name of a third task, the any structured information in the structured information set, and the question information into the machine learning model, the third task being used for selecting structured information matching the question information; and
generating information indicating whether the any structured information matches the question information based on outputs of a plurality of atomic capabilities corresponding to the third task within the machine learning model.

8. The method according to claim 1, wherein generating the response information corresponding to the question information based on the target structured information comprises:
generating the response information corresponding to the question information based on the target structured information and the question information.

9. The method according to claim 8, wherein generating the response information corresponding to the question information based on the target structured information and the question information comprises:
inputting a representation vector of a sequence consisting of the name of a fourth task, the target structured information, and the question information into the machine learning model, the fourth task being used for generating the response information; and
generating the response information corresponding to the question information based on outputs of a plurality of atomic capabilities corresponding to the fourth task within the machine learning model.

10. (canceled)

11. A smart question answer method, wherein the method comprises:
receiving question information from a terminal;
querying target structured information matching the question information from a structured information set corresponding to preset text information;
generating response information corresponding to the question information based on the target structured information; and
feeding back the response information to the terminal.

12. An electronic device, comprising:
a memory;
a processor; and
a computer program;
wherein the computer program is stored in the memory and is arranged for being executed by the processor to implement the following steps:
analyzing preset text information to obtain a structured information set corresponding to the preset text information;
acquiring question information;
querying target structured information matching the question information from the structured information set; and
generating response information corresponding to the question information based on the target structured information.

13. (canceled)

14. (canceled)

15. The method according to claim 1, wherein the structured information set is a Document Graph.

16. The method according to claim 15, wherein the preset text information is pre-stored information in a server.

17. The method according to claim 16, wherein the server is arranged for performing information extraction and question answer mining on the preset text information in an offline state to obtain the Document Graph.

18. The method according to claim 1, wherein the question information is a user interrogative sentence, or the question information is a declarative question.

19. The method according to claim 1, wherein the target structured information matching the question information is selected from a Document Graph through knowledge grounding.

20. The method according to claim 3, wherein information extraction is denoted as the first task, and the first task is decomposed into four atomic capabilities including text understanding, structure generation, context understanding, and text generation.

21. The method according to claim 5, wherein question answer mining is denoted as the second task, and the second task is decomposed into four atomic capabilities including text understanding, structure generation, context understanding, and text generation.

22. The method according to claim 7, wherein knowledge selection is denoted as the third task, and the third task is decomposed into four atomic capabilities including text understanding, dialogue understanding, matching, and text generation.

23. The method according to claim 9, wherein response generation is denoted as the fourth task, and the fourth task is decomposed into five atomic capabilities including dialogue understanding, dialogue management, text generation, knowledge utilization, and text understanding.
